(19) United States
(12) Patent Application Publication
(10) Pub. No.: US 2015/0226617 A1
(43) Pub. Date: Aug. 13, 2015

(54) USING IN-PROCESS HEAT FLOW AND DEVELOPING TRANSFERABLE PROTOCOLS FOR THE MONITORING, CONTROL AND CHARACERIZATION OF A FREEZE DRYING PROCESS

(71) Applicant: Millrock Technology, Inc, Kingston, NY (US)

(72) Inventors: Taylor N. Thompson, Kingston, NY (US); Edgar La Borde, Poughkeepsie, NY (US); Weijia Ling, Bethlehem, PA (US)

(21) Appl. No.: 14/526,575

(22) Filed: Oct. 29, 2014

Related U.S. Application Data
(60) Provisional application No. 61/938,764, filed on Feb. 12, 2014.

(51) Int. Cl. G01K 13/02; F26B 5/06

(52) U.S. Cl. CPC G01K 13/02; F26B 5/06; G01K 2013/024

(57) ABSTRACT

A method of monitoring and controlling a freeze drying process in a freeze drying apparatus having walls, shelves and a number of containers positioned on different areas of the shelves and containing product to be freeze dried. One or more product containers are selected that are representative of the positions of the product containers in different areas of the shelves. One or more heat flux sensors are positioned between the selected product containers and adjacent portions of the walls and/or shelves. The heat transfer between the selected containers and the adjacent wall or shelf portions is measured during the freezing and/or drying stages of the freeze drying process to determine critical process parameters that are used to develop or calculate freeze drying recipes, protocols and profiles that can be transferred between different freeze dryers.

### CROSS-REFERENCE TO RELATED APPLICATIONS

This application claims the priority of Provisional Patent Application No. 61/938,764 filed on Feb. 12, 2014 and entitled CHARACTERIZATION OF THE FREEZE DRYING PROCESS USING IN-PROCESS HEAT FLOW AND DEVELOPING TRANSFERABLE PROTOCOLS.

### BACKGROUND OF THE INVENTION

1. Field of the Invention

The present invention relates to a method for the monitoring, control and characterization of a freeze drying process and, more particularly, to the use of heat flux measurement to define the heat and mass transfer characteristics and a design space for both a piece of equipment or for a specific freeze drying application such as a container type, product and fill.

2. Description of the Background Art

Traditionally only temperature is measured from various points of a system to monitor and control the freeze drying process. However, knowing temperature alone is not enough to control and optimize the freeze drying process, since temperature change is the end result of a heat transfer event. In most cases, the moment an undesirable temperature change is detected, it is too late to make any correction to fix it.

Traditional freeze drying process control is inefficient open loop control due to limited feedback from product temperature and only being able to control the heat transfer fluid temperature from the point at which it flows into the shelf stack. Depending on the different product loads (i.e.,: quantity, size and fill of product or vials) as well as the equipment construction (i.e.,: shelf construction, fluid pump size and flow rate, etc.) the actual shelf surface temperature varies, although the inlet fluid temperature remains constant. In addition, the heat transfer coefficient changes with vacuum level and product container. This means that the same inlet shelf temperature may result in different product temperatures and therefore different freezing and drying results. The missing link in this control loop is heat flux measurement between shelf and product or from the radiant and convective energy of the equipment when the container is not contacting the shelf surface.

Freezing Step

Freezing, in the freeze drying process, consists of a nucleation process and a post nucleation thermal treatment to produce a crystal structure that concentrates the previously dissolved product into a fixed matrix between the ice crystals. Typically, nucleation occurs in a random fashion due to differences in heat transfer resulting in inconsistent crystallization across a batch which results in different drying performance and inconsistent product results. Proper crystal structure allows an elegant cake to be produced which also reduces the total drying time. To produce a consistent crystal structure that aids drying, controlled nucleation is combined with a proper thermal treatment.

Temperature sensors do not provide the feedback required for consistent crystallization process control. For example, during freezing the product may not change temperature, such as during removing latent heat in the freezing step. Although the product temperature doesn't change, there is a significant heat transfer event taking place.

During post nucleation latent heat removal, the speed of heat transfer has a major impact on crystal size, orientation and distribution. The crystal structure dramatically influences the drying performance and final product appearance. Measuring the heat flow enables better control of the freezing process. This method enables control of the shelf temperature during thermal events when there is no product temperature change.

Drying Step

Drying can be further divided into primary drying and secondary drying steps. Primary drying is a sublimation process where ice in a frozen product turns directly into vapor which is then condensed on a cold condensing surface leaving behind a matrix of concentrated product in the vial or tray on the shelf. Secondary drying is a desorption process. The remaining moisture in the concentrated product matrix is reduced to a level that is best for product long term stability.

Typically, optimized drying requires a process to efficiently remove water without losing the product matrix structure created during the freezing step. The key here is keeping the product at the maximum allowed temperature while still below the critical temperature. The critical temperature is the product temperature above which the product melts and/or the matrix collapses.

There may also be applications when some form of collapse is required. The process can also be monitored, optimized and controlled for these applications.

From a process control perspective, cycle optimization results in a shelf temperature and chamber pressure combination that balances the heat and mass flow and maintains the product at its optimum temperature. Traditionally this is a very challenging task which involves a multi-step trial and error approach, since measuring temperature and pressure alone cannot solve the heat and mass flow balance problem.

Some methods that are currently used for in-process measurement in freeze drying systems are:

MTM—An in-process technique that only calculates the product temperature based on pressure rise measurements. This technique is limited to critical batch sizes and does not provide mass flow information. It can only provide intermittent measurement no faster than every half hour. Measurements are limited to the first half of a cycle as it loses its accuracy in the second half of the cycle.

TDLAS—Tunable Diode Laser—An in-process technique that measures mass-flow through a duct using a laser. This is an expensive technique that works only during the drying stage of the freeze drying process. Only equipment with an external condenser can be fitted with TDLAS. The instrument itself significantly extends the length of the vapor duct and limits the maximum vapor flow rate through the duct to the condenser.

Two container differential heat flux measurement—described in U.S. Pat. No. 5,367,786 is a heat flux based process control method which measures the difference in heat flux between a process monitoring container and a reference container on a single heating or cooling surface. Since no two containers are identical, especially glass vials used in the apparatus, there is a limit to the accuracy of the measurement. Placement of an empty reference container among the sublimating product containers significantly changes the heat transfer mechanism on both measuring and referencing points. As heat transfer can happen between an empty reference container and product containers, measuring accuracy of the differential heat flux can be compromised. Placing a metal foil based radiant shield between two containers further changes the heat transfer mechanism between heating or cooling surfaces. The fundamental limitation of this method is that it significantly changes the heat transfer mechanism, which the method is trying to measure. In a production scale system, placement of the measuring apparatus is impractical. It also requires a temperature probe being directly placed in a product container which is considered invasive. In view of the above limitations, this method has never been widely adopted in either lab or production applications.

Freezing

Crystal structure may very well be the most important physical property to control in the freeze drying process. However, most of the concentration on improving the freeze drying process has centered on the sublimation or primary drying phase. Since the sublimation process is the longest step in freeze drying, improvements can result in higher output and better product consistency.

Placing containers on a shelf and lowering the shelf temperature, as is done in the majority of freeze dryers, results in non-homogeneous freezing of the product in the vials due to different degrees of super-cooling. The result is varying crystal structures across the vials caused by different nucleation temperatures and rates. The variation in crystal structure results in varying sublimation rates and therefore product inconsistencies. Crystal structure includes both ice crystals and product crystals for crystalline products.

Primary drying is the longest step of the freeze drying process. Most of the effort for process improvement has focused on measuring and controlling the product temperature as close to its critical point as possible to shorten the cycle. However, without proper ice structures in the frozen product there is a limit to how much faster cycles can be performed without compromising end product quality. Producing a better product crystal structure, through proper freezing, can result in both higher yields due to more uniform cake structure and shorter primary drying cycles due to reduced cake resistance. In general, larger crystals are easier to freeze dry, while small crystals impede sublimation thus lengthening the process. The speed of freezing has a direct effect on the size and type of crystal. Faster freezing produces a smaller crystal, while slower freezing produces are larger crystal. Changes in freezing rate result in varying crystal structures.

The challenge to creating a proper crystal structure is that the typical freezing process does not control the heat flow to the product and therefore crystal growth varies. Placing vials on a shelf and lowering the shelf temperature, as is done in the majority of freeze dryers, results in heterogeneous nucleation across the batch and heterogeneous crystal growth in the vials. The randomness of freezing is due to different degrees of super-cooling and variations in heat flow during the ice crystal growth process. It is important to understand that the rate of crystal growth varies even though the rate of shelf temperature change may not.

The main challenge during this stage of freezing is that nucleation is random and product temperature change does not occur during the phase change of free water from liquid to solid. The rate of crystal growth is dependent on the heat transfer efficiency of the application and equipment. The heat flow changes significantly as the shelf is cooled and the product freezes. The changing heat flow results in an inconsistent ice structure inside the vial and across the batch.

In order to create the most consistent crystal structure in the container and across the batch a common starting point and a method for controlling the rate of crystal growth is required. To improve on the current process of freezing, a method for controlled nucleation combined with a method for monitoring and controlling the heat flow during crystallization is required. Producing a controlled nucleation event provides a consistent starting point across the batch for freezing, while controlling the heat flow during crystal formation enables growth of more ideal crystal structures. The goal for nucleation is to have all of the vials nucleate at the same time, same temperature and at the same rate. The result will be a consistent starting point across the batch for controlling crystal growth during crystal formation inside the vial.

It is important to point out that controlled nucleation by itself does not significantly reduce primary drying times. Controlled nucleation provides a homogeneous starting point, but it is proper control of super-cooling and control of post-nucleation crystal growth that can produce a reduction in primary drying time. Nucleation only crystalizes 3-19% of the available water and therefore up to 97% of crystal growth occurs post-nucleation. Although controlled nucleation provides a consistent starting point for crystal growth across the batch, control of the crystal growth post-nucleation has the biggest positive effect on reducing primary drying times and increasing product quality and consistency. For example, sucrose super-cooled to −10 C, nucleated, and then cooled rapidly will result in a small crystal structure and minimal improvement in primary drying times. Therefore, post-nucleation thermal treatment is critical to a uniform and freeze drying friendly crystal structure inside the vial.

### BRIEF SUMMARY OF THE INVENTION

Freeze drying process monitoring and control can be enhanced by reacting to heat flux changes detected before temperature changes occur. One method of measuring heat flux is to use heat flux sensors that are designed to obtain a precise direct reading of thermal transfer through a surface in terms of energy per unit time per unit area.

The function of a heat flux sensor is to measure heat transfer (loss or gain) through the surface where it is mounted. It does this by indicating the temperature difference between opposite sides of a thin layer of separator material attached to measuring surfaces, thus providing a direct measurement of the heat loss or gain. Since the heat flux measurement is not limited to the surface, the heat flux sensor may be mounted in any appropriate manner to best measure the conductive, radiant or convective heat energy for the application. For example, on the shelf, on the container, on a container holder, or in any other suitable location.

The freeze drying process has two major steps: freezing and drying. Each step involves a different heat transfer dynamic between the shelf and product. Freezing is a cooling process with the heat transfer from the vial to the shelf. Drying is a heating process from the shelf to the product.

Using one or more heat flux sensors, both the freezing and drying steps can be monitored and controlled in a fashion that direct temperature measurement and other methods do not allow. The heat flux measurement method, therefore, provides a control of the entire process and is an in-situ Process Analytical Technology (PAT).

To produce a consistent crystal structure it is necessary to understand the major events that occur during freezing:

1—Nucleation;

2—Crystal growth in the freeze concentrate; and

3—Freeze Concentration (amorphous product) of the maximal freeze concentrate or freeze separation (eutectic product)

If each of these steps can be monitored and controlled, it is possible to produce a consistent crystal structure across an entire batch as well as inside each vial and therefore produce a significantly more consistent final product and even reduce the time of the primary drying phase.

1—Nucleation

The goal for nucleation is to have the material in the containers nucleate at the same time, same temperature and at the same rate. The result will be a consistent starting point for controlling crystal structure. Controlled nucleation provides the basis for control of the entire freezing process by providing a consistent starting point for all of the containers. To produce a controlled nucleation event the containers are cooled to a point where the liquid is super-cooled and all the containers have stabilized at a predetermined temperature. Once stable, a catalyst event is introduced to produce the nucleation event. The containers, for example, might be cooled to −5 C and held for 45 minutes to ensure the product is stable. The seeding crystals are introduced into the product chamber inducing nucleation in the container. The advantages of this approach include simplicity of implementation and low cost.

To ensure that the material in the containers has reached the predetermined temperature, the present method can be used to sense that the heat flow into the container has dropped to a level where there is no more temperature change taking place. This is done without the use of thermocouples in the container.

It is important to note that controlled nucleation by itself does not significantly reduce primary drying times. Controlled nucleation provides a homogeneous starting point, but it is the control of crystal growth during post-nucleation that can produce a reduction in primary drying time.

2—Crystal Growth

The remaining unfrozen material post-nucleation is an equilibrium freeze concentrate. As the shelf temperature is reduced further energy is removed from the container. The rate of crystal growth during this freezing step is typically not controlled and the changing heat flow results in an inconsistent ice structure inside the container. There are many factors that affect the rate of crystal growth including, for example, the efficiency of the equipment, the type of container, the volume of material, the percent solid content of the material, and the type of material such as crystalline or amorphous. Different finishes on the shelf, different heat transfer fluids, and different heat transfer fluid flow rates all have an effect on heat transfer efficiency. During the freezing process the equilibrium freeze concentrate crystalizes and forms a maximal freeze concentrate (Wg′). For example: sucrose has a maximal freeze concentrate of 20% water and 80% sucrose.

One of the main challenges during this stage of freezing is that temperature change does not occur during the phase change from liquid to solid and the rate of change is a result of heat transfer efficiency, which is different in each piece of equipment and for each application.

In situations with uncontrolled nucleation and controlled freezing the crystal structure at the bottom of the container is smaller than at the top. This results in non-uniform drying and the potential for melt-back or collapse. This is evident by shrinkage at the bottom of the cake toward the end of primary drying. Uncontrolled nucleation typically occurs from the bottom of the container, while controlled nucleation starts at the top of the container.

3—Freeze Separation or Concentration

Once the equilibrium freeze concentrate fully crystallizes, the process has reached the end of latent heat removal and the remaining maximal freeze concentrate begins to separate (eutectic) or concentrate (amorphous). By using the present method, a heat flow rate can be chosen and the rate of crystallization can be controlled until the product temperature is reduced below its eutectic or glass transition temperature. Control during this process produces a consistent structure throughout the maximal freeze concentrate.

### Design Space Determination

One or more heat flux sensors can be used for process monitoring and control. In addition, the process can be controlled from the highest heat flow or highest calculated product temperature and then the control sensor can be switched via software for progressive control through the process.

With the heat flux measurement information a cycle optimization design space can be defined and plotted in either 2D or, based on time, 3D. Product temperature isotherms, along with shelf temperature isotherms, can be plotted on a mass flux vs chamber pressure diagram. The resulting information can be used to select the optimum shelf temperature and chamber pressure for highest throughput possible in a specific freeze dryer. This quality by design approach maximizes process and product understanding with a minimum of experimentation.

Using the heat flux measurement method, one can plot cycle optimization design space with just one or two cycles. First, an ice slab sublimation test is performed to find the equipment limit lines. Second, a single product sublimation test is performed to plot all the shelf temperature isotherm lines. The traditional method to calculate vial heat transfer resistance (KO via weight loss requires a single vacuum set point per run, and several vacuum set points are required. This makes it an extremely lengthy and expensive process.

Another benefit from the heat flux method is limited product samples are required to finish the test run as long as they can cover the area of the sensor. Other methods like TDLAS require many more samples to generate enough vapor flow for accuracy of measurement.

In addition to ensuring that a protocol developed in a small lab freeze dryer is repeatable in a large production freeze dryer, the heat flux measurement method allows a Production Freeze Dryer to be characterized and then simulated on a lab scale unit. For example, the heat flux of an existing protocol can be measured and then repeated in a small system. Typically this is very difficult since the system performance and heat transfer dynamics are much different. Scaling from the lab to production is a major problem in the industry. The main advantage of controlling nucleation and controlling the heat flow is that the freezing profile developed in any freeze dryer can be transferred completely successfully into any other freeze dryer.

For simplicity, freeze drying “profile” refers to the recipe, protocol, process or steps that define the shelf temperature and product chamber pressure or other critical process parameters for a specific freeze drying application. Heat transfer properties differ between freeze dryers and also differ at different shelf or product locations making transfer of the freeze drying profile difficult and time intensive. With the equipment heat transfer characterized in accordance with the present invention, the freeze drying profile can be translated to allow reliable and easy transfer between freeze dryers.

### BRIEF DESCRIPTION OF THE DRAWINGS

FIG. 1 is an elevational view of a portion of a shelf in a first embodiment of a freeze drying apparatus having one or more product containers mounted thereon with a heat flux sensor mounted on the top surface of the shelf beneath the vials;

FIG. 2 is an elevational view of a portion of a shelf in a second embodiment of a freeze drying apparatus having a heat flux sensor embedded in the shelf beneath one or more product containers mounted on the shelf;

FIG. 3 is an elevational view of a portion of a shelf in a third embodiment of a freeze drying apparatus having a heat flux sensor mounted flush in a slot in the top surface of the shelf beneath the containers;

FIG. 4 is an elevational view of a portion of a shelf in a fourth embodiment of a freeze drying apparatus having a heat flux sensor mounted inside a product container holder or support that is not in full contact with the shelf;

FIG. 5 is an elevational view of a portion of a shelf in a fifth embodiment of a freeze drying apparatus having heat flux sensors mounted on product containers that are mounted on a holder or support in suspended relation to the shelf;

FIG. 6 is a schematic plan view showing multiple sensors mounted on a single shelf in a freeze drying apparatus for sensing edge effects;

FIG. 7 is a schematic plan view showing a matrix of sensors mounted on a single shelf in a freeze drying apparatus;

FIG. 8 is an elevational view of a portion of a further embodiment of a freeze drying apparatus wherein one or more heat flux sensors are mounted on walls or shelves that are in contact with or adjacent to bulk product to be freeze dried in the apparatus; and

FIG. 9 is a block diagram showing critical process parameters and the calculation of critical information for control of the freeze drying process with the use of the critical process parameters.

### DETAILED DESCRIPTION OF THE INVENTION

Implementation of the present heat flux measurement method in a freeze drying process control opens a new door to optimization and enables a validation trail of the freeze drying cycle. It is based on continuous real time measurement, as opposed to other techniques which only take occasional batch based average estimates or calculations after the cycle is finished. It works throughout the cycle from freezing to the end of drying. It can be easily transferred from lab scale to production as a true Process Analytical Technology (PAT).

Using heat flux to verify the process in-situ can confirm, for the first time, that the process has performed within acceptable parameters. In addition, feedback can be used to prevent damage to the product in process before it happens, in events such as equipment malfunction.

Heat flux sensing provides information that can identify process changes that could accidently occur, such as a change in vial, formulation changes, freeze drying machine performance and other critical parameters that previously have not been measureable.

During a power loss, the cake structure could be affected. Heat flux sensing could be used to confirm that no negative effects in cake structure have occurred, thus saving a batch product.

Using a heat flux sensor has major advantages over all other methods for monitoring and controlling a freeze drying process including:

1. Can be used for both the freezing and drying portions of the freeze drying process;

2. Minimally invasive-does not change the heat transfer mechanism;

3. Real-time, continuous measurement;

4. Can be installed on all freeze drying equipment from lab to production scale;

5. Works with both internal and external condenser configurations;

6. Can be used to determine end of primary drying, to determine the end of freezing,
to verify the freezing profile was proper,
to verify the primary drying process was proper,
to determine the end of secondary drying, and
to verify the secondary drying process was proper. 7. Eliminates the need for multiple product runs at different pressures to determine an acceptable performance envelope;

8. Acts as a PAT tool and enables real-time monitoring and control of the process, from laboratory to production;

9. Provides in-situ information for Quality by Design with minimum cycle runs;

10. It is equipment and container independent allowing seamless cycle transfer;

11. Is batch size independent, works from a small lot to a full load (MTM and TDLAS require a large batch);

12. Performs direct measurement and does not rely on estimates in calculations (MTM requires that the volume of the chamber be estimated);

13. Can identify changes in critical process parameters, i.e., vial construction, formulation, equipment performance, etc.;

14. Can be used to verify cake integrity post power failure or other equipment or process failure;

15. Low cost; and/or

16. Can be easily implemented.

The heat flux sensors can be implemented in various ways. For example, on most laboratory scaled systems the sensor can be mounted on the top surface of the shelf or flush with the shelf surface, while on production scale systems it may be embedded inside the shelf. The mounting location is not limited to the shelf for monitoring and control. It may also be mounted on the walls or other surfaces of the freeze drying apparatus that are near the containers or bulk product and may have a significant heat transfer effect on the process.

Any suitable type of heat flux sensor may be used. As an illustrative example, a low thermal capacitance and low thermal impedance heat flux sensor is suitable for this type of application.

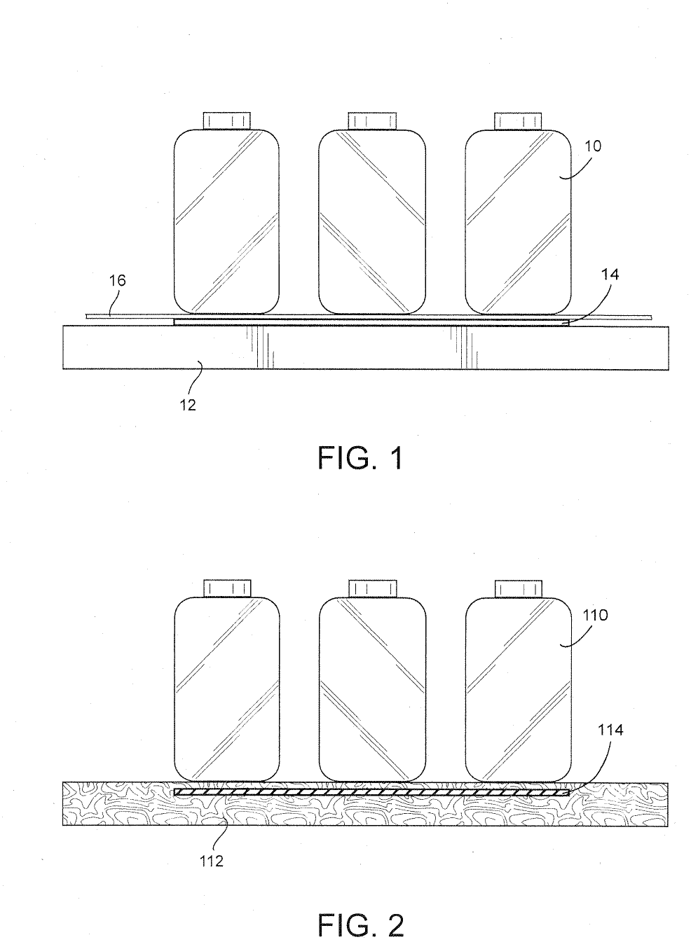

As shown in FIG. 1, one or more product containers 10 are mounted on the center or other portions of one or more shelves 12 in a freeze drying apparatus so as to be representative of the product vials (not shown) in other positions on the shelves 12. One or more heat flux sensors 14 are mounted on the upper surface of the shelves 12 and/or adjacent walls (not shown). A stainless metal foil or other layer 16 expediting heat transfer may be positioned between each heat flux sensor 14 and the product containers 10 to insure accurate measurement of the heat loss or gain between the product containers 10 and the shelves 12.

A modified embodiment is shown in FIG. 2 wherein one or more product containers 110 are mounted on the center or other portions of one or more shelves 112 in a freeze drying apparatus and one or more heat flux sensors 114 are embedded inside the shelves 112 and/or adjacent walls (not shown) beneath or adjacent to the product containers 110.

As illustrative examples, the embodiment of FIG. 1 may be used in laboratory scaled systems and the embodiment of FIG. 2 may be used in production scale systems. The sensors may be permanently or temporarily mounted.

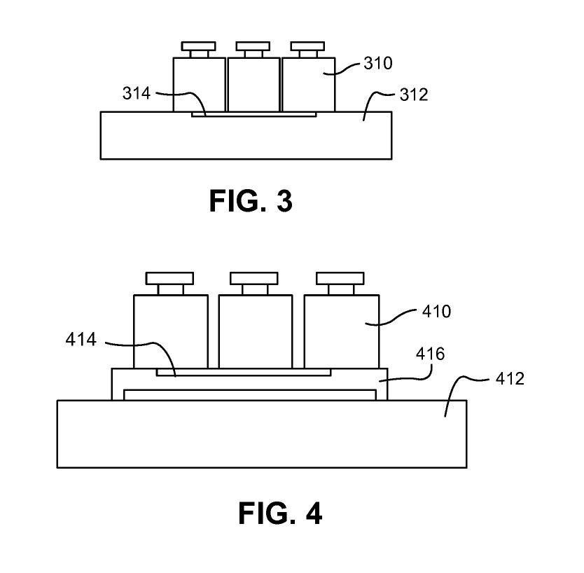

A third embodiment is shown in FIG. 3 wherein a heat flux sensor 314 is mounted flush within a slot in the shelf 312 beneath the product containers 310.

A fourth embodiment is shown in FIG. 4 wherein a heat flux sensor 414 is mounted inside a holder 416 supporting the product containers 410, the holder 416 not being in full contact with the shelf 412.

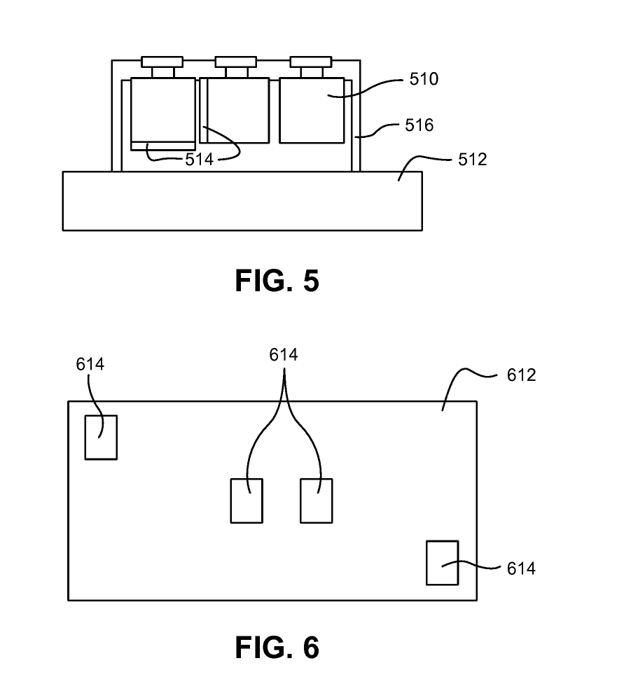

A fifth embodiment is shown in FIG. 5 wherein heat flux sensors 514 are mounted on product containers 510 mounted on a support frame 516 in suspended relation above the shelf 512.

FIG. 6 illustrates a freeze dryer shelf 612 having multiple heat flux sensors 614 mounted thereon in spaced relation to facilitate the sensing of edge effects.

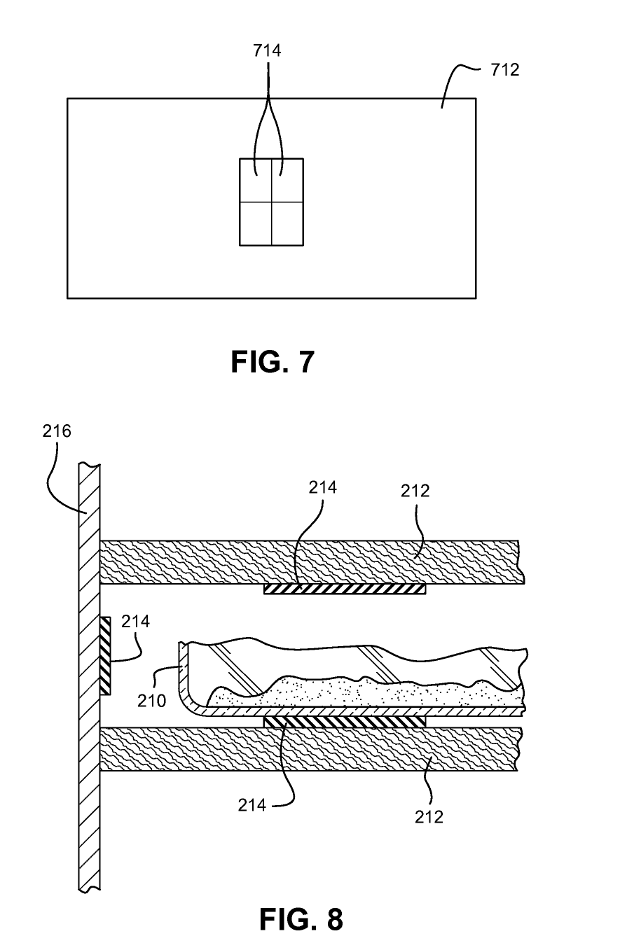

FIG. 7 illustrates a freeze dryer shelf 712 having a matrix of heat flux sensors 714 mounted thereon in closely spaced relation.

A further embodiment is shown in FIG. 8 wherein bulk product P to be freeze dried is placed in a tray or trays 210 mounted on one or more shelves 212 of a freeze drying apparatus having walls or other surfaces 216. One or more heat flux sensors 214 may be mounted on the shelves 212 adjacent to and above or below the bulk product P. One or more heat flux sensors 214 may also be mounted on the walls or other surfaces 216 of the freeze drying apparatus or product containers adjacent to bulk product P on the shelves 212. The heat flux sensors 214 are mounted in selected positions on the shelves 212 or walls 216 adjacent to selected bulk product P so as to be representative of all of the bulk product in the freeze drying apparatus. The heat flux sensors 214 may be mounted on or embedded into the shelves 212, walls 216 or other surfaces adjacent to the bulk product P.

In order to create the most consistent crystal structure in the container and across the batch a common starting point and a method for controlling the rate of crystal growth is required. Controlled nucleation provides a common starting point by nucleating all the vials at the same temperature, rate, and time. Once the product is nucleated, crystal growth begins in the unsaturated solution. By measuring the heat flow during crystal growth the freezing rate can be determined. Combining this information with the latent heat of ice, it is possible to predict and measure the end of latent heat removal and the end of unsaturated solution crystallization if the heat flow can be measured and controlled.

In most freezing profiles the shelf temperature is ramped to a low temperature at a controlled rate, for example to −40° C. at 0.5° C./min. When the heat flow is monitored it is very apparent that the crystal growth changes dramatically during the crystallization process. With feedback from the heat flux sensors the shelf temperature can be controlled to keep the heat flow at a predetermined level throughout the crystal growth phase of freezing. The result is a homogeneous ice crystal structure throughout the vial and throughout the batch. The crystal growth can be controlled at different rates to develop different crystal sizes.

The heat flux sensor provides in-process information for Heat Flow (dq/dt). With this information a series of calculations can be performed to provide critical information for control of the freeze drying process. Three critical parameters can be determined, including the Vial Heat Transfer Coefficient (Kᵥ), Mass Flow (dm/dt), and Product Resistance (Rₚ). The calculations enable the process parameters to be predicted instead of using the typical ‘after-the-fact’ open-loop control feedback of thermocouples. This makes heat flux based control a true process analytical tool. Once Kv has been determined the product temperature at the bottom of the vial (T_{b}) can be calculated, thus eliminating the need for a thermocouple for monitoring product temperature

### Kᵥ-Vial (Container) Heat Transfer Coefficient

Vial (container) heat transfer coefficient Kᵥ, is an important process variable which has a direct impact on product temperature during the drying step. Its value depends on container physical properties, chamber vacuum level, and shelf surface finish.

One known method to calculate Kᵥ involves multiple sublimation tests which require the operator to perform a short run and then remove the product from the freeze dryer to measure the actual weight loss in a period of time after each test cycle. This process is performed for each different vacuum level to produce a performance curve. This approach is time consuming and error-prone.

Using the present heat flux measurement method, Kᵥ can be determined (calculated) in real time during the cycle without the time and labor intensive sublimation tests. Having in-process knowledge of Kᵥ totally eliminates the process uncertainty caused by heat transfer efficiency differences. One can calculate the product ice temperature based on shelf surface temperature of Kᵥ.

Vial (container) heat transfer coefficient (Kᵥ) and Product Temperature (T_{b}) are very useful for Quality by Design (QbD). Any changes in container characteristics and formulation can be identified.

$$\frac{d q}{d t} = {K}_{V} {A}_{V} ( {T}_{s} - {T}_{b} ) = > {K}_{V} = \frac{\frac{d q}{d t}}{{A}_{v} ( {T}_{s} - {T}_{b} )}$$

Where:

$$\frac{d q}{d t}$$

=Heat transfer measured from heat flux sensor

Kᵥ=Vial (container) heat transfer coefficient to be calculated

Aᵥ=Outer cross section area of vial

Tₛ=Shelf surface temperature from measurement

T_{b}=Product temperature at the bottom center of a vial

To calculate the Kᵥ a thermocouple is required to measure T_{b}. This is required one time only. Once Kᵥ has been determined, the T_{b} can be calculated and the thermocouple eliminated. If Kv is not constant then Kv vs time can be stored and used for transferring protocols or the heat flow profile can be used.

### Dm/dt—Mass Flow

Heat Flow measurement enables the control to be load sensitive. Traditional control on fluid inlet temperature has no real measurement of cooling or heating load on the shelf. A change in load results in a different thermal treatment profile on the product. This is a major obstacle for transferring a process to a different piece of equipment or different batch size. Control based on heat flow makes the process fully transferable and scalable to any size of machine and load.

Mass Flow information gives a real time estimate of when the primary drying cycle can be finished. Previously, end of cycle could only be detected when it happened. With heat flow measurement, it is possible to predict the end of a cycle. During the cycle any process parameter change causes a change in mass flow which can be monitored.

Heat Flow and Mass Transfer equation:

$$\frac{d q}{d t} = Δ {H}_{s} \frac{d m}{d t} = > \frac{d m}{d t} = \frac{\frac{d q}{d t}}{Δ {H}_{s}}$$

Where:

$$\frac{d q}{d t}$$

=Heat transfer measured from heat flux sensor

ΔHₛ=Heat of sublimation of ice

$$\frac{d m}{d t}$$

=Mass transfer rate to be calculated

### Rp=Product Resistance

Product resistance Rₚ is the resistance to sublimation caused by a dry layer of the product. Its value depends on the ice crystal size, orientation and distribution which is a product of freezing. Most current equipment has no direct measurement of Rₚ. This means that there is no way to verify that the product was frozen the same way from batch to batch. With a real time reading of Rₚ the ice matrix property can be verified from the moment drying process starts. During the drying process, if the process product temperature causes the dry layer to collapse or crack, a change of product resistance can be monitored in real time. This measurement offers a complete trace of product structure during the drying process, allowing process verification.

Mass Transfer and Product Resistance equation:

$$\frac{d m}{d t} = \frac{{A}_{p} ( {P}_{t} - {P}_{c} )}{{R}_{p}} = > {R}_{p} = \frac{{A}_{p} ( {P}_{t} - {P}_{c} )}{\frac{d m}{d t}}$$

Vapor Pressure over ice equation:

$${P}_{t} = 6.112 {e}^{( \frac{22.46 {T}_{b}}{272.62 + {T}_{b}} )}$$

(Guide to Meteorological Instruments and Methods of Observation 2008)

Where:

$$\frac{d m}{d t}$$

=Mass transfer rate to be calculated

Aₚ=Inner cross section area of vial

Pᵢ=Vapor pressure of ice calculated from ice temperature Tb

P_{c}=Chamber pressure

Rₚ=Resistance of the dried product layer to be calculated

T_{b}=Product temperature at the bottom center of a vial

The above equations are for example only.

a. Other more accurate equations may be used;

b. Other equations may also be used to determine other application specific information.

The heat flow information can be used to determine^{.}

Heat Flow
Knowing the heat flow during different stages of freeze drying is critical to developing a robust profile. Traditional control on fluid inlet temperature has no real measurement of cooling or heating load on the shelf. A change in load requires a different thermal treatment profile on the product, which is produced by changing the shelf temperature. Knowing the heat flow characteristics of the equipment and the application remove the obstacles for transferring a process to a different piece of equipment or different batch size. Shelf temperature profiles based on heat flow makes the process fully transferable and scalable to any size of machine and load.
Freezing:
   determine that the product is ready for controlled nucleation;
   control the shelf temperature for controlled crystal growth;
   determine that the product has reached the end of freezing and is ready for primary drying;
Primary drying:
   Calculate the product temperature during the entire primary drying process without a temperature sensor in the product;
   Determine the end of primary drying (when the heat flow approaches zero)

Product Temperature
Determine the product temperature through calculation to eliminating the need for invasive temperature measurement methods, such as thermocouples;
Verify the product did not rise above the critical temperature;
Feed back to the control system to adjust the shelf temperature to constantly keep the product below its critical temperature or at an acceptable temperature while maximizing the shelf temperature, thus reducing primary drying times.

Mass Flow
Calculate the end of primary drying time:
   Calculate the mass flow and remaining material to determine the amount of time that is left in primary drying;
Define a design space for equipment (QbD—Quality by Design):
   Adjust the vacuum level and shelf temperature to develop design space in a single run.

Process Analytical Technology (PAT)
To determine if any changes to the process have occurred, the heat flow will change. Process changes could be the result of, but not limited to:
   Container characteristics
   Fill levels
   Equipment performance
   Other factors

Features:
True Process Analytical Technology for monitoring and control of the entire freezing and drying process;
QbD Tool for developing design space;
Identify changes in process:
   Change in containers;
   Change in fill amount.
Determine if collapse or melt-back is taking place.

To characterize a freeze drying application, for a specific container, product, quantity of container and container fill, the user enters application specific information and the heat flux measurement system will measure, display and store the measured parameters and the calculated (derived from thermodynamic balance equations) critical process parameters continuously or on selected intervals. To define a design space, the shelf temperature or chamber pressure can be changed by the operator, either manually or via the freeze dryer control system.

The heat transfer and process information collected can be used to translate freeze drying profiles between freeze dryers through a series of calculations, by controlling critical process parameters in each system, or by translating critical process measurements into a shelf temperature and product chamber pressure profile for the target freeze dryer. The target freeze dryer is a freeze dryer that has been characterized and will receive a translated freeze drying profile that was developed on a different freeze dryer. The translation is based on a pivot variable such as container heat transfer coefficient, heat flow, or other process parameters.

A freeze drying profile based on one or more critical process parameters, such as shelf temperature profile, heat flow, mass flow, or product temperature can be created on one freeze dryer and then translated using the container conductivity or other value for transfer to a target freeze dryer.

Transfer between freeze dryers and scaling from the lab to production is a major problem in the industry. This methodology will enable freeze drying profiles to be transferred in less time while also providing information for improving cycle performance.

The concept of the present invention, therefore, is to first provide process information that has been previously unavailable and second to provide the information to enable an improved or optimized freeze drying profile to be produced based on the container heat transfer coefficient as determined using heat flux measurement.

Using heat flux for monitoring and control in a development system produces an improved or optimized process. The improved or optimized process is transferred as a recipe, protocol, or profile based on one or more critical process parameters, such as shelf temperature profile, heat flow, mass flow, or product temperature. The profile could be in the form of a limited number of straight-line approximations or as a continuous temperature profile such as a trend-line or waveform or polynomial equation or similar concept.

The object is to determine a design space for the freeze drying profile from which the user can define a process profile. The profile can be translated based on each freeze dryer's characterization and transferred to a cycle that repeats in a manner that reproduces the same result, including freezing the product for an improved ice crystal structure during freezing and keeping the product at or near its maximum temperature during the drying process. The result is reduced processing times and improved product quality without the need for heat flux monitoring and control on the target freeze dryer.

The heat flux monitoring system can operate in a stand-alone mode or can be interfaced with the freeze dryer control system for further automation.

Stand-Alone

The stand-alone system provides the ability to add heat flux monitoring to any freeze dryer. First, a method to characterize the heat transfer characteristics of the target freeze dryer is required. Heat flow monitoring or a similar method can be used to determine the critical heat transfer characteristics. The characteristics of the target system can be determined as a design space for different container types, fills, and at different pressure levels. There will be a design space for the freezing process, the primary drying process and the secondary drying process.

The stand-alone monitoring system can be used to characterize a Target System. The critical process parameters determined during characterization of a system will be stored and used to develop profiles on the development system or to modify a profile that was developed on the development system.

Integrated

Second, a method for developing an optimized profile is possible. One method for optimizing the process is to use heat flow measurement and control for a specific application to develop an improved or optimized process. For further optimization, a method for controlled nucleation can be used. The combination of controlled nucleation and heat flow control produces a fully optimized profile.

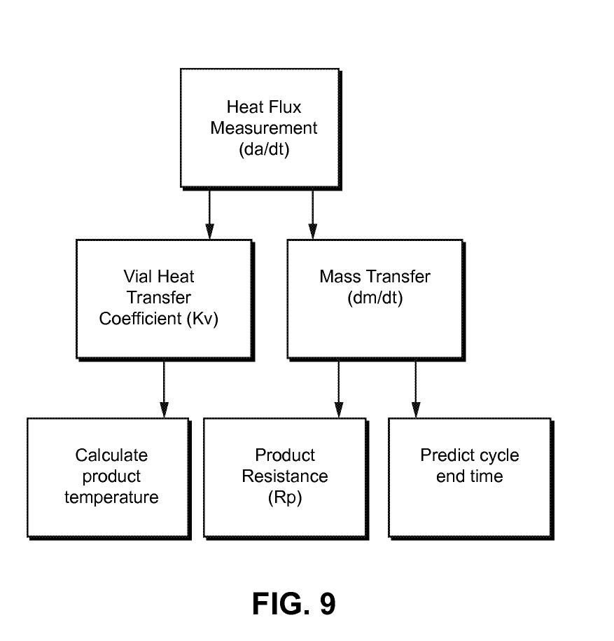

### Critical Process Parameters (FIG. 9)

Critical Process Parameters include, but are not limited to:

Shelf temperature profile—Ts

Heat flow, dQ/dt

Vial (container) Heat Transfer Coefficient—Kv

Mass-flow, dM/dt

Product temperature, Tp

Product Cake Resistance, Rp

The heat flux sensor provides in-process information for Heat Flow (dQ/dt). With this information a series of calculations can be performed to provide critical information for control of the freeze drying process. Three critical parameters can be determined, including the Vial (container) Heat Transfer Coefficient (KO, Mass Flow (dM/dt), and Product Resistance (Rₚ). The calculations enable the process parameters to be predicted instead of using the typical ‘after-the-fact’ open-loop control feedback of temperature sensors. This makes heat flux based control a true process analytical tool. Once Kv has been determined, the product temperature at the bottom of the vial (Tb) can be calculated, thus eliminating the need for a thermocouple for monitoring product temperature

To automate the process, a software program on the freeze dryer can be used to execute a design space cycle while the data is collected. The data can be collected in continuous form or at discrete shelf temperature and vacuum set-points or whatever the pertinent parameters are.

Kv Design Space Example for a specific vial type and formulation fill.

Several runs will need to be done to determine the process that produces the best results. For example, one run for each of the different freezing profiles; without nucleation, with controlled nucleation, and with controlled nucleation and controlled ice crystal growth post-nucleation.

Without Controlled Nucleation
Freezing
Primary Drying Matrix
   Shelf Temperature (deg C.)
      −40, −30, −20, −10, −5, 0, 5, 10
   Vacuum Level (mT)
      50, 75, 100, 150, 200
Secondary Drying Matrix
   Shelf Temperature (deg C.)
      10, 15, 20, 25, 30, 35, 40, 45, 50
   Vacuum Level (mT)
      10, 25, 50, 75, 100, 150, 200

With Controlled Nucleation
Freezing
Primary Drying Matrix
   Shelf Temperature (deg C.)
      −40, −30, −20, −10, −5, 0, 5, 10
   Vacuum Level (mT)
      50, 75, 100, 150, 200
Secondary Drying Matrix
   Shelf Temperature (deg C.)
      10, 15, 20, 25, 30, 35, 40, 45, 50
   Vacuum Level (mT)
      10, 25, 50, 75, 100, 150, 200

With Controlled Nucleation and Controlled Heat Flow (Controlled Ice Crystal Growth) Post-Nucleation
Freezing
Primary Drying Matrix
   Shelf Temperature (deg C.)
      −40, −30, −20, −10, −5, 0, 5, 10
   Vacuum Level (mT)
      50, 75, 100, 150, 200
Secondary Drying Matrix
   Shelf Temperature (deg C.)
      10, 15, 20, 25, 30, 35, 40, 45, 50
   Vacuum Level (mT)
      10, 25, 50, 75, 100, 150, 200

Characterization data can be stored for each of the freezing profiles without nucleation, with controlled nucleation, and with controlled nucleation and controlled ice crystal growth post-nucleation. Each freezing profile will then have critical parameters determined during freezing, primary drying and secondary drying.

The critical process data can be stored in a table, csv file, a continuous stream, graphically or in any other appropriate manner.

### Freeze Drying Profiles

The Freeze Drying profiles can be in the form of:
1—Discrete steps, such as straight-line approximations of the optimized profile.
2—Discrete steps, such as ramps and holds.
3—A table of set-points based on discrete steps in time
4—A trend-line
5—A polynomial equation
   a. Either a single polynomial or multiple polynomials.
6—A waveform
7—Any other method that produces a time vs critical parameter profile

The form of profile used for transfer will depend on the capability of the targets control system.

Translating process profiles:

Develop a Profile on the Development system and translate the Profile for the Target system.
Develop an optimized profile on the development system where the heat transfer characteristics are known, then post-development translate the optimized profile based on the design space heat transfer characteristics of the target system to produce an acceptable profile for the target system. The translation is possible since both systems' heat transfer characteristics have been identified.

Development scenarios:

Using heat flux technology a freezing profile, primary drying profile, and secondary drying profile. Develop a baseline optimized freeze dry process profile that is robust and efficient on a development freeze dyer. The process data is collected and stored along with the heat transfer characteristics used. To transfer the profile, the target system critical heat transfer characteristics are identified. A conversion program is used to translate the baseline development cycle to a target system shelf temperature profile or heat flow profile.

The target freeze dryer can execute the profile based on the significant process parameters that may be either without feedback from sensors or with feedback from a heat flow monitoring system to verify proper operation.

Equipment Design Space Determination:

The heat flux monitoring system can be used to determine the design space of a freeze dryer.

With the heat flux measurement information, a cycle optimization design space can be defined and plotted. Product temperature isotherms, along with shelf temperature isotherms, can be plotted on a mass flux vs chamber pressure diagram. The resulting information can be used to select the optimum shelf temperature and chamber pressure for highest throughput possible in a specific freeze dryer. This quality by design approach maximizes process and product understanding with a minimum of experimentation.

Using the heat flux measurement method, one can plot cycle optimization design space with just two cycles run. First, an ice slab sublimation test is performed to find the equipment limit lines. Second, a single product sublimation test is performed to plot all the shelf temperature isotherm lines. The traditional method to calculate vial heat transfer resistance (Kv) via weight loss requires a single vacuum set point per run, and several vacuum set points are required. This makes it an extremely lengthy and expensive process.

Another benefit from the heat flux method is limited product samples are required to finish the test run as long as they can cover the area of the sensor. Other methods like TDLAS require many more samples to generate enough vapor flow for accuracy of measurement.

From the foregoing description, it will be readily seen that the present heat flux method is simple, inexpensive, easily implemented and is a minimally invasive, reliable, efficient and accurate method for monitoring and controlling both the freezing and drying portions of the freeze drying process of different types of freeze drying apparatus.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of monitoring and controlling a freeze drying process in a freeze drying apparatus having walls, one or more shelves and one or more containers positioned on different areas of the shelves and containing product to be freeze dried, comprising:
selecting one or more containers that are representative of the positions of all of the containers in different areas of the shelves, measuring the heat flow between the selected product containers and adjacent wall or shelf portions during freezing and/or drying stages of the freeze drying process to determine critical process parameters that are used to develop or calculate freeze drying recipes, protocols and profiles that can be transferred between freeze dryers when the critical process parameters of the freeze dryers are known.

2. The method of claim 1 wherein the critical process parameters comprise shelf temperature profile, heat flow, vial (container) heat transfer coefficient, mass flow, product temperature and/or product cake resistance.

3. The method of claim 2 wherein information on the critical process parameters is stored in different forms for translating a freeze drying profile to other freeze dryers.

4. The method of claim 2 wherein the critical process parameters are used to characterize a freeze dryer at a specific shelf temperature and vacuum level.

5. The method of claim 2 wherein the critical process parameters are used to determine freeze dryer design space for varying shelf temperatures and vacuum levels.

6. The method of claim 2 wherein the critical process parameters are used to characterize freeze drying applications for container type, product and fill at different shelf temperatures and vacuum levels.

7. The method of claim 6 wherein the critical parameters are used to determine design space for the freeze drying applications.

8. The method of claim 2 wherein the critical process parameters are used to control the product temperature.

9. The method of claim 2 wherein the vial (container) heat transfer coefficient is determined by the following formula:
$$\frac{d q}{d t} = {K}_{v} {A}_{v} ( {T}_{s} - {T}_{b} ) = > {K}_{v} = \frac{\frac{d q}{d t}}{{A}_{v} ( {T}_{s} - {T}_{b} )}$$
Where:
$$\frac{d q}{d t}$$
=Heat transfer measured from heat flux sensor
Kᵥ=Vial heat transfer coefficient to be calculated
Aᵥ=Outer cross section area of vial
Tₛ=Shelf surface temperature from measurement
T_{b}=Product temperature at the bottom center of a vial

10. The method of claim 2 wherein the vial (container) heat transfer coefficient is used to calculate the product temperature at the bottom of a vial or tray.

11. The method of claim 2 wherein the mass flow is determined by the following formula:
$$\frac{d q}{d t} = Δ {H}_{s} \frac{d m}{d t} = > \frac{d m}{d t} = \frac{\frac{d q}{d t}}{Δ {H}_{s}}$$
Where:
$$\frac{d q}{d t}$$
=Heat transfer measured from heat flux sensor
ΔFₛ=Heat of sublimation of ice
$$\frac{d m}{d t}$$
=Mass transfer rate to be calculated

12. The method of claim 2 wherein the product cake resistance is determined by the following formula:
$$\frac{d m}{d t} = \frac{{A}_{p} ( {P}_{t} - {P}_{c} )}{{R}_{p}} = > {R}_{p} = \frac{{A}_{p} ( {P}_{t} - {P}_{c} )}{\frac{d m}{d t}}$$
Vapor Pressure over ice equation:
$${P}_{i} = 6.112 {e}^{( \frac{22.46 {T}_{b}}{272.62 + {T}_{b}} )}$$
(Guide to Meteorological Instruments and Methods of Observation 2008)
Where:
$$\frac{d m}{d t}$$
=Mass transfer rate to be calculated
Aₚ=Inner cross section area of vial
Pᵢ=Vapor pressure of ice calculated from ice temperature T_{b}
P_{c}=Chamber pressure
Rₚ=Resistance of the dried product layer to be calculated
T_{b}=Product temperature at the bottom center of a vial.

13. A method of monitoring and controlling a freeze drying process in a freeze drying apparatus having walls, one or more shelves and one or more containers positioned on different areas of the shelves and containing product to be freeze dried, comprising:
selecting one or more containers that are representative of the positions of all of the containers in different areas of the shelves, and
measuring the heat flow between the selected product containers during the freezing stage of the freeze drying process to control crystal growth during freezing with controlled nucleation.

14. A method of monitoring and controlling a freeze drying process in a freeze drying apparatus having walls, one or more shelves and one or more containers positioned on different areas of the shelves and containing product to be freeze dried, comprising:
selecting one or more containers that are representative of the positions of all of the containers in different areas of the shelves, and
measuring the heat flow between the selected product containers and adjacent walls or shelves during the freezing stage of the freeze drying process to control crystal growth during freezing post-nucleation.

15. A method of monitoring and controlling a freeze drying process in a freeze drying apparatus having walls, one or more shelves and one or more containers positioned on different areas of the shelves and containing product to be freeze dried, comprising:
selecting one or more containers that are representative of the positions of all of the containers in different areas of the shelves, and
measuring the heat flow between the selected product containers and adjacent walls or shelves during the freezing stage of the freeze drying process to control crystal growth during freezing post-nucleation to control crystal growth during freezing without controlled nucleation.
